(19) United States
(12) Patent Application Publication
(10) Pub. No.: US 2015/0377240 A1
(43) Pub. Date: Dec. 31, 2015

(54) TURBOCHARGER HAVING VANED COMPRESSOR INLET RECIRCULATION PASSAGE

(71) Applicant: Electro-Motive Diesel Inc., LaGrange, IL (US)

(72) Inventor: Shakeel NASIR, Willowbrook, IL (US)

(73) Assignee: Electro-Motive Diesel Inc.

(21) Appl. No.: 14/318,519

(22) Filed: Jun. 27, 2014

(51) Int. Cl. F04D 23/00; F02C 6/12; F04D 29/44

(52) U.S. Cl. CPC F04D 23/008; F04D 29/441; F02C 6/12

(57) ABSTRACT

A turbocharger is disclosed for use with an engine. The turbocharger may include a housing at least partially defining a compressor shroud and a turbine shroud, a turbine wheel disposed within the turbine shroud, a compressor wheel disposed within the compressor shroud, and a shaft connecting the turbine wheel to the compressor wheel. The turbocharger may also include an annular recirculation passage extending between an inlet located radially outward of the compressor wheel and an outlet located upstream of the compressor wheel, and a generally ring-shaped hub at least partially forming the recirculation passage. The hub may have an outer surface. The turbocharger may further include a plurality of first vanes disposed circumferentially around the outer surface, and a plurality of second vanes disposed circumferentially around the outer surface. The second vanes may be shorter than the first vanes.

### TECHNICAL FIELD

The present disclosure is directed to a turbocharger and, more particularly, to a turbocharger having a vaned compressor inlet recirculation passage.

### BACKGROUND

Internal combustion engines such as, for example, diesel engines, gasoline engines, and gaseous fuel powered engines are supplied with a mixture of air and fuel for subsequent combustion within the engines that generates a mechanical power output. In order to increase the power output generated by this combustion process, an engine can be equipped with a turbocharged air induction system. The turbocharged air induction system includes a turbocharger that uses exhaust from the engine to compress air flowing into the engine, thereby forcing more air into a combustion chamber of the engine than the engine could otherwise draw into the combustion chamber. This increased supply of air allows for increased fueling, resulting in an increased power output. A turbocharged engine typically produces more power than the same engine without turbocharging.

A conventional turbocharger includes a compressor housing and a centrifugal compressor wheel centrally disposed within the housing and driven to rotate by a connected turbine wheel. In some applications, turbochargers can include a compressor recirculation passage located at a periphery of the compressor wheel inlet. The recirculation passage recirculates a portion of compressed air back into the inlet of the compressor at certain operating conditions. The recirculation of air can help to improve compressor stage stability and range in certain operating conditions.

An exemplary recirculation passage for a compressor is disclosed in U.S. Pat. No. 6,945,748 of Svihla et at. that issued on Sep. 20, 2005 (the '748 patent). Specifically, the '748 patent describes a centrifugal compressor including an annular inlet air recirculation channel extending from a first slot adjacent to a compressor impeller to a second slot preceding an inlet to the compressor impeller. The recirculation channel is formed between a recirculation channel ring and a compressor housing. The recirculation channel ring is mounted by radial struts connected to the housing. The recirculation channel has a variable cross section that can provide aerodynamically efficient air flow.

Although the recirculation channel of the '748 patent may be adequate for some applications, it may still be less than optimal. In particular, the recirculation channel of the '748 patent may still direct a non-uniform high-swirl and poorly guided flow back so the inlet of the compressor, which can result in relatively high incidence losses, lower aerodynamic performance, and marginal compressor stage stability and range at different operating conditions.

The turbocharger of the present disclosure solves one or more of the problems set forth above and/or other problems of the prior art.

### SUMMARY

In one aspect, the present disclosure is directed to a turbocharger. The turbocharger may include a housing at least partially defining a compressor shroud and a turbine shroud, a turbine wheel disposed within the turbine shroud, a compressor wheel disposed within the compressor shroud, and a shaft connecting the turbine wheel to the compressor wheel. The turbocharger may also include an annular recirculation passage extending between an inlet located radially outward of the compressor wheel and an outlet located upstream of the compressor wheel, and a generally ring-shaped hub at least partially forming the recirculation passage. The hub may have an outer surface. The turbocharger may further include a plurality of first vanes disposed circumferentially around the outer surface, and a plurality of second vanes disposed circumferentially around the outer surface. The second vanes may be shorter than the first vanes.

In another aspect, the present disclosure is directed to a compressor recirculation ring for a turbocharger. The recirculation ring may include a generally ring-shaped huh having an outer surface. The recirculation ring may also include a plurality of first vanes disposed circumferentially around the outer surface, and a plurality of second vanes disposed circumferentially around the outer surface. Each of the second vanes may be tangent to one of the first vanes.

In yet another aspect, the present disclosure is directed to a compressor recirculation ring for a turbocharger. The recirculation ring may include a generally ring-shaped hub having an outer surface. The recirculation ring may also include a plurality of first vanes disposed circumferentially around the outer surface, and a plurality of second vanes disposed circumferentially around the outer surface. Each of the second vanes may be disposed in between adjacent first vanes.

### BRIEF DESCRIPTION OF THE DRAWINGS

FIG. 1 is a schematic illustration of an exemplary disclosed power system;

FIG. 2 is a cross-sectional illustration of an exemplary disclosed turbocharger that may be used in conjunction with the power system of FIG. 1;

FIG. 3 is a pictorial illustration of an exemplary disclosed recirculation ring that may be used in conjunction with the turbocharger of FIG. 2;

FIG. 4 is a pictorial illustration of exemplary disclosed vanes that may be used in conjunction with the recirculation ring of FIG. 3; and

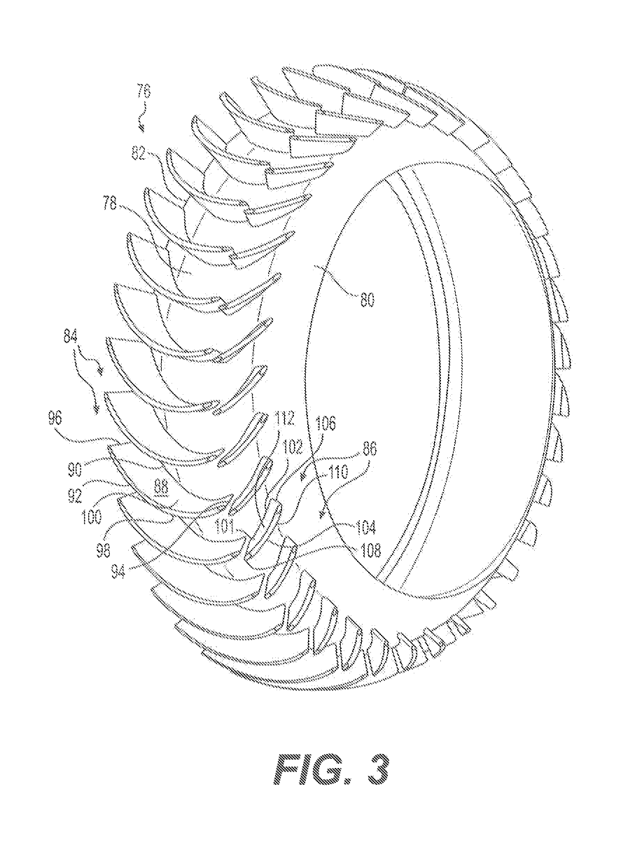

FIG. S is a pictorial illustration of another embodiment of the recirculation ring of FIG. 3.

### DETAILED DESCRIPTION

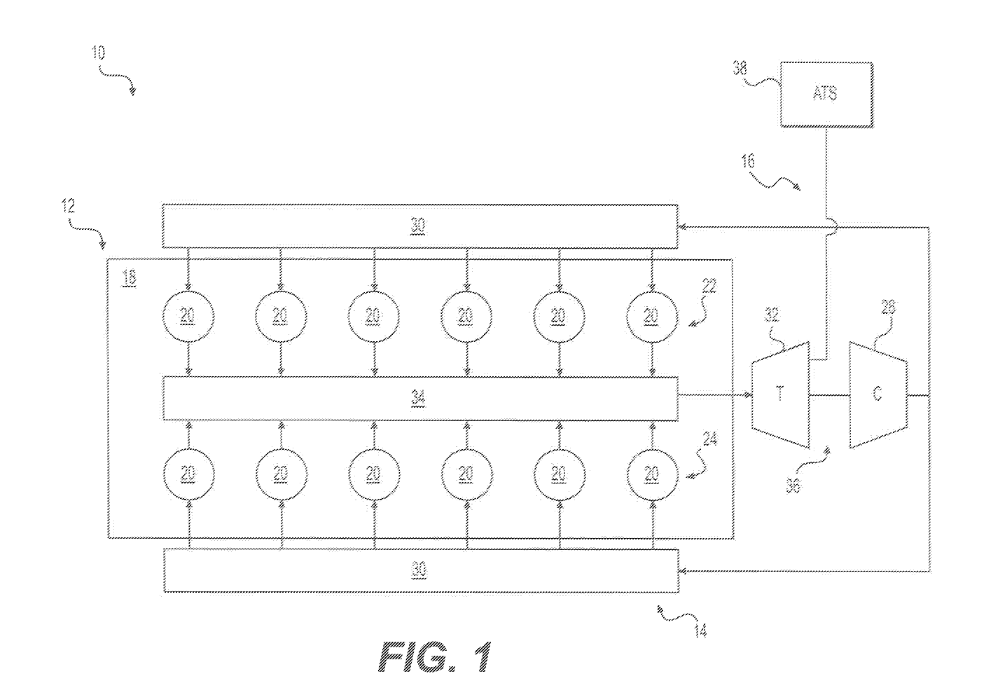

FIG. 1 illustrates a power system 10 having an engine 12, an air induction system 14. and an exhaust system 16. For the purposes of this disclosure, engine 12 is depicted and described as a four-stroke diesel engine. One skilled in the art will recognize, however, that engine 12 may be any other type of combustion engine such as, for example, a two- or four-stroke gasoline or gaseous fuel-powered engine. Air induction system 14 may be configured to direct air or a mixture of air and fuel into engine 12 for combustion. Exhaust system 16 may be configured to direct combustion exhaust from engine 12 to the atmosphere.

Engine 12 may include an engine block 18 that at least partially defines a plurality of cylinders 20. A piston (not shown) may be slidably disposed within each cylinder 20 to reciprocate between a top-dead-center position and a bottom-dead-center position, and a cylinder head (not shown) may be associated with each cylinder 20. Each cylinder 20, piston, and cylinder head may together at least partially define a combustion chamber. In the illustrated embodiment, engine 12 includes twelve cylinders 20 arranged in a V-configuration (i.e., a configuration having first and second banks 22, 24 or rows of cylinders 20). However, it is contemplated that engine 12 may include a greater or lesser number of cylinders 20 and that cylinders 20 may be arranged in an inline configuration, in an opposing-piston configuration, or in another configuration, as desired.

Air induction system 14 may include, among other things, at least one compressor 28 Chat may embody a fixed geometry compressor, a variable geometry compressor, or any other type of compressor configured to receive air and compress the air to a desired pressure level. Compressor 28 may direct air to one or more intake manifolds 30 associated with engine 12. It should be noted that air induction system 14 may include multiple compressors 28 arranged in a serial configuration, a parallel configuration, or a combination serial/parallel configuration.

Exhaust system 16 may include, among other things, an exhaust manifold 34 connected to one or both of banks 22, 24 of cylinders 20. Exhaust system 16 may also include at least one turbine 32 driven by the exhaust from exhaust manifold 34 to rotate compressor 28 of air induction system 14. Compressor 28 and turbine 32 may together form a turbocharger 36. Turbine 32 may be configured to receive exhaust and convert potential energy in the exhaust to a mechanical rotation. After exiting turbine 32, the exhaust may be discharged to the atmosphere through an aftertreatment system 38 that may include, for example, a hydrocarbon doser, a diesel oxidation catalyst (DOC), a diesel particulate filter (DPF), and/or any other treatment device known in the art, if desired. It should be noted that exhaust system 16 may include multiple turbines 32 arranged in a serial configuration, a parallel configuration, or a combination serial/parallel configuration, as desired.

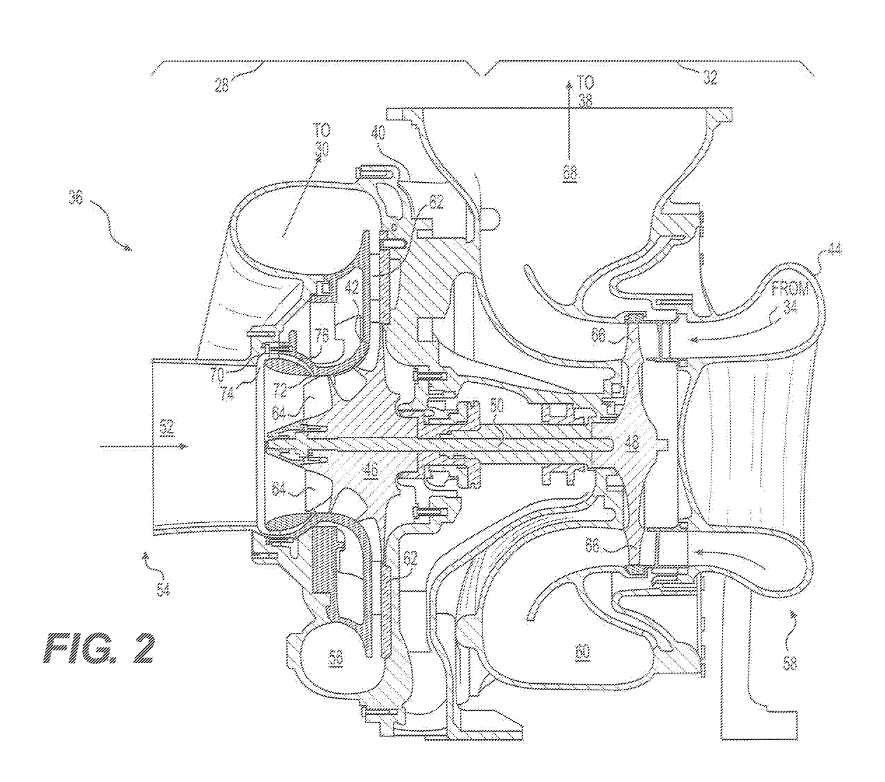

As shown in FIG. 2, compressor 28 and turbine 32 of turbocharger 36 may be connected to each other via a common shaft 50. Turbocharger 36 may include a housing 40 at least partially defining compressor and turbine shrouds 42, 44, respectively, that are configured to house corresponding compressor and turbine wheels 46, 48. Compressor shroud 42 may include an axially-oriented inlet 52 located at a first axial end 54 of turbocharger 36, and a tangentially-oriented volute 56 located between first axial end 54 and a second axial end 58 of turbocharger 36. Turbine shroud 44 may include a volute 60 located between volute 56 and second axial end 58 of turbocharger 36.

As compressor wheel 46 is rotated, air may be drawn axially into turbocharger 36 via inlet 52 and directed toward compressor wheel 46. Blades 64 of compressor wheel 46 may then push the air radially outward in a spiraling fashion and into intake manifolds 30 (referring to FIG. 1) via an outlet volute (not shown). In some embodiments, before exiting compressor 28, the air may pass through a diffuser 62 located within the outward radial flow path at a periphery of compressor wheel 46.

Similarly, as exhaust from exhaust manifold 34 (referring to FIG. 1) is directed axially, radially, and tangentially inward toward turbine wheel 48, the exhaust may posh against blades 66 of turbine wheel 48, causing turbine wheel 48 to rotate and drive compressor wheel 46 via shaft 50. Alter passing through turbine wheel 48, the exhaust flow may exit axially outward through a turbine outlet 68 located at second axial end 58 of turbocharger 36 into aftertreatment system 38 (referring to FIG. 1).

In the disclosed embodiment, compressor 28 is equipped with a recirculation passage 70. Recirculation passage 70 may be an annular passage extending between an inlet 72 located radially outward of blades 64 and an outlet 74 located upstream of blades 64 and compressor wheel 46. Recirculation passage 70 may be formed between a recirculation ring 76 and compressor shroud 42. Recirculation passage 70 may be configured to direct a portion of compressed air back towards inlet 52, where it is redirected again towards compressor wheel 46 at certain operating conditions. The recirculation of air may improve compressor stability and range at certain operating conditions. In some embodiments, about 2-35% of compressor stage fluid flow may be recirculated through recirculation passage 70.

As shown in FIG. 3, recirculation ring 76 may include a generally ring-shaped hub having an outer surface 78 and axial end surfaces 80, 82 on opposing sides of outer surface 78. In some embodiments, recirculation ring 76 may have a plurality of primary vanes 84 and a plurality of secondary vanes 86 extending outward in three dimensions from outer surface 78. Vanes 84 may be disposed circumferentially around outer surface 78. Vanes 86 may be disposed adjacent to vanes 84. More specifically, vanes 86 may be tangent to vanes 84. In some embodiments, vanes 86 may have a shorter length than vanes 84. As the flow recirculates through recirculation passage 70, it may first pass through a row of vanes 86 and then through a row of vanes 84.

Vanes 84, 86 may be configured to diffuse the flow and allow relatively high flow turning with lower flow losses as compared to a single row of vanes at certain operating conditions. For example, vanes 84, 86 may have high solidity and high camber (e.g., have a substantially high turning angle) to alter flow swirl and minimize aerodynamic losses in recirculation passage 70. In addition, vanes 84, 86 may be circumferentially symmetric or asymmetric to further reduce flow losses inside recirculation passage 70, improve circumferential flow uniformity and incidence at inlet 52, and improve compressor stage stability near surge (or reduced flow conditions).

Each vane 84 may include an airfoil 88 having a lower face (also known as a hub face) 90 that is connected to outer surface 78, an opposing upper face (also known as a shroud face) 92 that is oriented towards an inner surface of shroud 42, a leading edge 94 that is oriented towards inlet 72, a trailing edge 96 that is opposite to leading edge 94, a low-pressure side (also known as the suction side) 98, and an opposing high-pressure side (also known as the pressure side) 100. It is contemplated that trailing edge 96 may be located closer to outlet 74 than leading edge 94.

Similarly, each vane 86 may include an airfoil 101 having a lower face (also known as a huh face) 102 that is connected to outer surface 78, an opposing upper face (also known as a shroud face) 104 that is oriented towards an inner surface of shroud 42, a leading edge 106 that is oriented towards inlet 72, a trailing edge 108 that is opposite to leading edge 106, a low-pressure side (also known as the suction side) 110, and an opposing high-pressure side (also known as the pressure side) 112. It is contemplated that trailing edge 108 may be located closer to outlet 74 than leading edge 106.

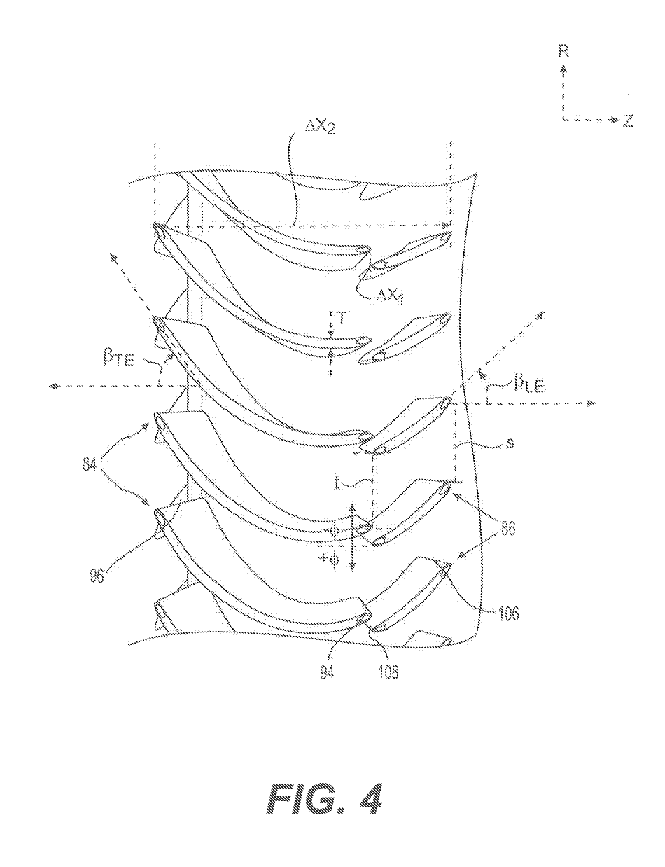

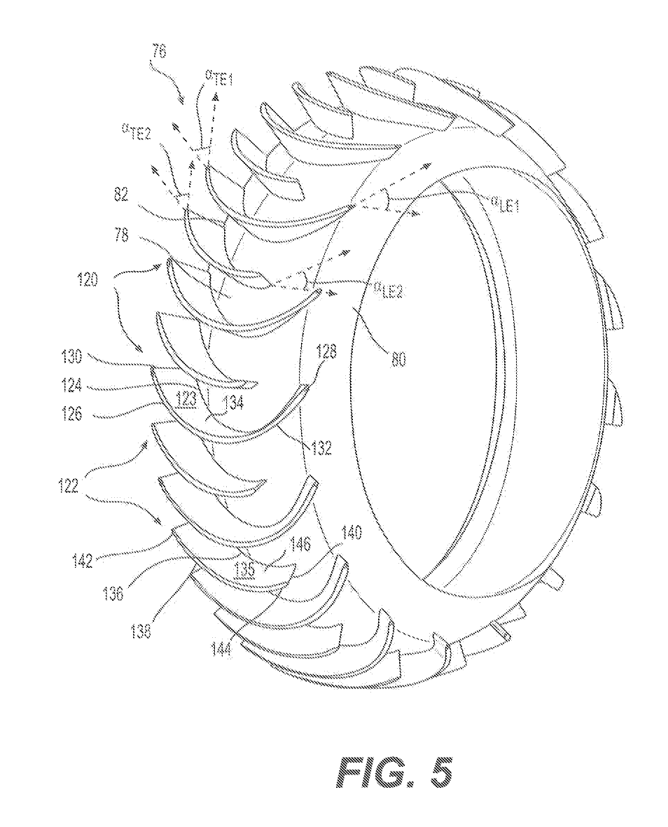

FIG. 4 illustrates a side-view of recirculation ring 76 and vanes 84, 86. In a meridional plane shown in FIG. 4, an R-axis defines a radial direction, and a Z-axis defines an axial direction along a meridional length of vanes 84, 86. For the purposes of this disclosure, an axial spacing ΔX₁ between vanes 84, 86 may refer to an axial distance between leading edge 94 of vane 84 and trailing edge 108 of an adjacent vane 86. An axial spacing ΔX₂ between vanes 84, 86 may refer to an axial distance between trailing edge 96 of vane 84 and leading edge 106 of an adjacent vane 86. An axial overlap AO may be defined as a ratio of axial spacing ΔX₁ to axial spacing ΔX₂ (AO=ΔX₁/ΔX₂). A radial spacing t between vanes 84, 86 may refer to a radial distance between leading edge 94 of vane 84 and trailing edge 108 of adjacent vane 86. A radial spacing s between adjacent vanes 86 may refer to a radial distance between adjacent leading edges 106 of adjacent vanes 86. A pitch P may be defined as a ratio of radial spacing t to radial spacing s (P=t/s). A leading edge angle β_{LE}. may refer to an angle between leading edge 106 of vane 86 and the Z-axis of the meridional plane. A trailing edge angle β_{TE} may refer to an angle between trailing edge 96 of vane 84 and the Z-axis of the meridional plane. A camber C of vanes 84, 86 (i.e., a change in angle from leading edge 106 of vane 86 to trailing edge 96 of vane 84) may be defined as a difference between leading edge angle β_{LE} and trailing edge angle β_{TE} (C=β_{LE}−β_{TE}). A shift angle Φ may refer to a relative turning angle around the Z-axis of vane 84 to an adjacent vane 86. A thickness T may refer to an axial distance between low- and high-pressure sides 98, 100 of vanes 84 that is generally orthogonal to a camber line passing through a lengthwise center of vanes 84.

The disclosed geometry of vanes 84, 86 has been selected to alter swirl with improved flow guidance and reduced aerodynamic losses at different loading conditions through recirculation passage 70 and back into compressor wheel 46, thereby reducing flow misalignment (e.g., incidence) and resulting in improved performance of turbocharger 36. In addition, the disclosed geometry of vanes 84, 86 may diffuse flow inside recirculation passage 70, improve circumferential flow uniformity by reducing flow losses in recirculation passage 70, and improve compressor stage stability near surge (i.e., reduced flow conditions).

In the disclosed embodiment, vanes 84, 86 have an axial overlap AO of about −0.1-0.15. Vanes 84, 86 may also have a pitch P of greater than or equal to about 0.8. Each vane 86 may have a leading edge angle β_{LE} of about −80-80°. Each vane 84 may have a trailing edge angle β_{TE} of about 0-90°. Vanes 84, 86 may have a camber C of about −170-80°. Vane 86 may have a shift angle Φ of about −15-10°. In addition, a solidity of vanes 84 may be substantially different than a solidity of vanes 86. For example, a solidity of vanes 84 may be substantially higher than a solidity of vanes 86. Each of these geometrical features may help to reduce flow misalignment (e.g., incidence) and result in improved performance of turbocharger 36. for example, the angle ranges described above may help to increase a turning angle in recirculation passage 70 to reduce flow swirl and minimize flow losses therein.

In some embodiments, the recirculated air may be injected into a flow of air into compressor wheel 46 radially or axially, depending on an orientation of trailing edge 96 of vane 84. Also in some embodiments, vanes 84, 86 may be circumferentially symmetric. However, in other embodiments, vanes 84, 86 may be circumferentially asymmetric to further allow for compressor stage performance and stability improvement.

FIG. 5 shows an alternative embodiment of recirculation ring 76. In this embodiment, recirculation ring 76 has a plurality of main vanes 120 and a plurality of splitter vanes 122 extending outward in throe dimensions from outer surface 78. Vanes 120 may be disposed circumferentially around outer surface 78. Vanes 122 may be disposed circumferentially in between adjacent vanes 120. Vanes 122 may have a shorter length than vanes 120. For example, vanes 122 may have a length that is about 30-80% of a length of vanes 120. More specifically, leading edges 128 of vanes 120 may be about 30-80% upstream of leading edges 140 of vanes 122, while trailing edges 130 of vanes 120 may be circumferentially aligned with trailing edges 142 of vanes 122.

Similar to varies 84, 86, vanes 120, 122 may be configured to diffuse the flow, and allow high flow turning with lower flow losses as compared to a single row of identical vanes at certain operating conditions. For example, vanes 120, 122 may have high solidity, and high camber (e.g., have a substantially high turning angle) to alter flow swirl and minimize aerodynamic losses in recirculation passage 70. In addition, vanes 120, 122 may be circumferentially symmetric or asymmetric to further reduce mixing losses inside recirculation passage 70, improve circumferential flow uniformity and incidence at compressor inlet, and improve compressor stage stability near surge (or reduced flow conditions.

Each vane 120 may include an airfoil 123 having a lower face (also known as a hub face) 124 that is connected to outer surface 78, an opposing upper face (also known as a shroud lace) 126 that is oriented towards an inner surface of shroud 42, a leading edge 128 that is oriented towards inlet 72, a trailing edge 130 that is opposite to leading edge 128, a low-pressure side (also known as the suction side) 132, and an opposing high-pressure side (also known as the pressure sides 134. It is contemplated that trailing edge 130 may be located closer to outlet 74 than leading edge 128.

Similarly, each vane 122 may include an airfoil 135 having a lower face (also known as a hub face) 136 that is connected to outer surface 78, an opposing upper face (also known as a shroud face) 138 that is oriented towards an inner surface of shroud 42, a leading edge 140 that is oriented towards inlet 72, a trailing edge 142 that is opposite to leading edge 140, a low-pressure side (also known as the suction side) 144, and an opposing high-pressure side (also known as the pressure side) 146. It is contemplated that trailing edge 142 may be located closer to outlet 74 than leading edge 140.

For the purposes of this disclosure, a leading edge angle to α_{LE1} of vanes 120 may refer to an angle between leading edge 128 of vane 120 and the Z-axis of the meridional plane (referring to FIG. 4). A leading edge angle α_{LE2} of vanes 122 may refer to an angle between leading edge 140 of vane 122 and the Z-axis of the meridional plane (referring to FIG. 4). A trailing edge angle α_{TE1} of vanes 120 may refer to an angle between trailing edge 130 of vane 120 and the Z-axis of the meridional plane (referring to FIG. 4). A trailing edge angle α_{TE2} of vanes 122 may refer to an angle between trailing edge 142 of vane 122 and the Z-axis of the meridional plane (referring to FIG. 4).

The disclosed geometry of vanes 120, 122 has been selected to alter flow swirl with improved flow guidance, reduced airfoil aerodynamic loading, and reduced velocity gradients at different loading conditions through recirculation passage 70 and back into compressor wheel 46, in order to reduce flow misalignment (e.g., incidence) and result in improved performance of turbocharger 36. In addition, the disclosed geometry of vanes 120, 122 may diffuse flow inside recirculation passage 70, improve circumferential flow uniformity by reducing flow losses in recirculation passage 70, and improve compressor stage stability near surge (or reduced flow conditions).

In the disclosed embodiment, a leading edge angle α_{LE1} of vanes 120 is substantially different than a leading edge angle α_{LE2} of vanes 122. In addition, a trailing edge angle α_{TE1} of vanes 120 may be substantially different than a trailing edge angle α_{TE2} of vanes 122. Each of vanes 120, 122 may have a leading edge angle α_{LE1}, α_{LE2} in a range of about −80-80°. Each of vanes 120, 122 may have a trailing edge angle α_{TE1}, α_{TE2} in a range of about 0-90°. These angle ranges may help to increase a turning angle in recirculation passage 70 to reduce flow swirl and minimize flow losses therein.

In some embodiments, the recirculated air may be injected into a flow of an into compressor wheel 46 radially or axially, depending on an orientation of trailing edges 130, 142 of vanes 120, 122. Also in some embodiments, vanes 120, 122 may be circumferentially symmetric. However, in other embodiments, vanes 120, 122 may be circumferentially asymmetric to further allow for compressor stage performance and stability improvement.

### INDUSTRIAL APPLICABILITY

The disclosed turbocharger may be implemented into any power system application where charged air induction is utilized. In particular, the specific geometry of vanes 84, 86 or vanes 120, 122 in recirculation passage 70 may result in overall lower aerodynamic losses and, thus, improved performance, stability, and range of compressor 28. The uniform and well-guided flow exiting recirculation passage 70 may result in more uniform loading of compressor wheel 46. This may help to reduce cyclic loading on compressor wheel 46, extending the useful life of compressor wheel 48. Because air flow may be substantially uniform and well-guided to each blade 64 of compressor 28, mechanical and vibrational losses attributable to misaligned air flow and compressor blade geometry may be significantly reduced.

It will be apparent to those skilled in the art that various modifications and variations can be made to the disclosed turbocharger. Other embodiments will be apparent to those skilled in the art from consideration of the specification and practice of the disclosed turbocharger. It is intended that the specification and examples be considered as exemplary only, with a true scope being indicated by the following claims and their equivalents.

What is claimed is:

1. A compressor recirculation ring for a turbocharger, comprising:
a generally ring-shaped hub having an outer surface;
a plurality of first vanes disposed circumferentially around the outer surface; and
a plurality of second vanes disposed circumferentially around the outer surface, each of the second vanes being tangent to one of the first vanes.

2. The compressor recirculation ring of claim 1, wherein the second vanes are shorter than the first vanes.

3. The compressor recirculation ring of claim 1, wherein a solidity of the first vanes is substantially different from a solidity of the second vanes.

4. The compressor recirculation ring of claim 1, wherein an angle between an axial axis in a meridional plane of the second vanes and leading edges of the second vanes is about −80-80°.

5. The compressor recirculation ring of claim 1, wherein an angle between an axial axis in a meridional plane of the first vanes and trailing edges of the first vanes is about 0-90°.

6. The compressor recirculation ring of claim 1, wherein a change in angle between leading edges of the second vanes and trailing edges of the first vanes is about −170-80°.

7. The compressor recirculation ring of claim 1, wherein a ratio between a radial distance between leading edges of first vanes and trailing edges of adjacent second vanes, and a radial distance between adjacent leading edges of adjacent second vanes is greater than or equal to about 0.8.

8. The compressor recirculation ring of claim 1, wherein a ratio between an axial distance between trailing edges of the second vanes and leading edges of adjacent first vanes, and an axial distance between leading edges of the second vanes and trailing edges of adjacent first vanes is about −0.10 to 0.15.

9. The compressor recirculation ring of claim 1, wherein a turning angle in a radial direction between first vanes and adjacent second vanes is about −15-10°.

10. The compressor recirculation ring of claim 1, wherein the first vanes and the second vanes are disposed circumferentially symmetric around the outer surface.

11. The compressor recirculation ring of claim 1, wherein the first vanes and the second vanes are disposed circumferentially asymmetric around the outer surface.

12. A compressor recirculation ring for a turbocharger, comprising:
a generally ring-shaped hub having an outer surface;
a plurality of first vanes disposed circumferentially around the outer surface; and
a plurality of second vanes disposed circumferentially around the outer surface, each of the second vanes being disposed in between adjacent first vanes.

13. The compressor recirculation ring of claim 12, wherein the second vanes are shorter than the first vanes.

14. The compressor recirculation ring of claim 13, wherein a length of each of the second vanes is about 30-80% shorter than a length of each of the first vanes.

15. The compressor recirculation ring of claim 14, wherein trailing edges of the first vanes are circumferentially aligned with trailing edges of the second vanes.

16. The compressor recirculation ring of claim 12, wherein a first leading edge angle between an axial axis in a meridional plane of the first vanes and leading edges of the first vanes is substantially the different than a second leading edge angle between an axial axis in a meridional plane of the second vanes and leading edges of the second vanes.

17. The compressor recirculation ring of claim 16, wherein the first and second leading angles are in a range of about −80-80°.

18. The compressor recirculation ring of claim 12, wherein a first trailing edge angle between an axial axis in a meridional plane of the first vanes and trailing edges of the first vanes is substantially different than a second trailing edge angle between an axial axis in a meridional plane of the second vanes and trailing edges of the second vanes.

19. The compressor recirculation ring of claim 18, wherein the first and second trailing angles are in a range of about 0-90°.

20. The compressor recirculation ring of claim 12, wherein the first vanes and the second vanes are disposed circumferentially symmetric around the outer surface.

21. The compressor recirculation ring of claim 12, wherein the first vanes and the second vanes are disposed circumferentially symmetric around the outer surface.

22. A turbocharger, comprising:
a housing at least partially defining a compressor shroud and a turbine shroud;
a turbine wheel disposed within the turbine shroud;
a compressor wheel disposed within the compressor shroud;
a shaft connecting the turbine wheel to the compressor wheel;
an annular recirculation passage extending between an inlet located radially outward of the compressor wheel and an outlet located upstream of the compressor wheel;
a generally ring-shaped hub at least partially forming the recirculation passage, the hub having an outer surface;
a plurality of first vanes disposed circumferentially around the other surface; and
a plurality of second vanes disposed circumferentially around the outer surface, the second vanes being shorter than the first vanes.

23. The turbocharger of claim 22, wherein each of the second vanes are tangent to one of the first vanes.

24. The turbocharger of claim 22, wherein each of the second vanes are disposed in between adjacent first vanes.
